(19) United States
(12) Patent Application Publication
(10) Pub. No.: US 2017/0286560 A1
(43) Pub. Date: Oct. 5, 2017

(54) METHOD, DEVICE AND SYSTEM FOR DEVICE TROUBLESHOOTING SERVICE OF THE INTERNET OF THINGS

(71) Applicant: ZTE CORPORATION, Shenzhen, Guangdong Province (CN)

(72) Inventor: Weixiang SHAO, Shenzhen, Guangdong Province (CN)

(73) Assignee: ZTE Corporation, Shenzhen, Guangdong Province (CN)

(21) Appl. No.: 15/508,859

(22) PCT Filed: Apr. 29, 2015
(86) PCT No.: PCT/CN2015/077869

§ 371 Date: Mar. 3, 2017

(30) Foreign Application Priority Data
Sep. 4, 2014 (CN) 201410448845.7

(51) Int. Cl. G06F 17/30; H04L 12/26; H04L 29/08

(52) U.S. Cl. CPC G06F 17/30887; G06F 17/30368; H04L 67/10; H04L 43/0823; H04L 43/065; G06Q 10/20

(57) ABSTRACT

The disclosure discloses a method, device and system for device troubleshooting service of the Internet of things. The method includes: receiving a management operation or capability of a device troubleshooting service requested by an application entity and managing a requested target device according to the management operation or capability of the device troubleshooting service, and providing the application entity with at least one of an operation result and an operation state.

### TECHNICAL FIELD

The disclosure relates to the field of communications, and in particular to a method, device and system for a device troubleshooting service of the Internet of things.

### BACKGROUND

The Internet of things is an important part of a new generation of an information technology. As the name implies, the Internet of things is an internet that things are connected mutually. An international telecommunications union (ITU) internet report issued by an ITU defines the Internet of things as followings: it is an internet, based on information sensing devices such as a two-dimensional code identification device, a radio-frequency identification device (RFID), an infrared sensor, a global positioning system and a laser scanner etc., connecting any objects to an internet according to an agreement protocol, exchanging information and communicating, so as to realize intelligent identification, positioning, tracking, monitoring and managing.

A concept of M2M is usually introduced in the Internet of things, which means man to man, man to machine, and machine to machine. Essentially, an interaction of man to machine and machine to machine mostly aims at realizing an information interaction of man to man. An M2M network is a main expression of the Internet of things currently, which includes a machine to machine communication network, a man to machine communication network and a machine to man communication network. A device of the M2M network mainly includes a M2M terminal, a M2M gateway and a M2M server.

FIG. 1 shows a schematic diagram of a system of the Internet of things according to the related art, as shown in FIG. 1, the Internet of things is divided into a private Internet of things (generally providing service for a single institution), a public Internet of things (providing service for public or a large-scale user group), a community Internet of things (providing service for a related “community” or an institutional group) etc. Currently the Internet of things is widely applied in different industries, including an intelligent agriculture, a smart grid, an intelligent transportation, intelligent logistics, an intelligent healthcare, and a smart home etc. Especially, each of these industries deploys professional Internet of things, including corresponding professional Internet of things/M2M device, such as a terminal, a gateway and a server and other platform devices.

A telecom operator is a provider of a public communication service, which also plays a role of a public Internet of things server when providing the Internet of things/M2M service. As for devices of the private Internet of things, the community Internet of things and a professional Internet of things of each industry, current telecom operator, acting as a public Internet of things server, needs an effective technical solution to uniformly implement the device troubleshooting service.

### SUMMARY

As for a problem that a telecom operator, acting as a public Internet of things server, cannot uniformly manage a device troubleshooting service of devices in a public Internet of things and other Internet of things domains, the embodiments of disclosure disclose a method, device and system for a device troubleshooting service of the Internet of things, so as at least to solve the problem above.

An embodiment of the disclosure discloses a method for a device troubleshooting service of the Internet of things, including: receiving a management operation or capability of a device troubleshooting service requested by an application entity, and managing a target device according to the management operation or capability of the device troubleshooting service; and providing the application entity with at least one of an operation result and an operation state.

In an example embodiment, the target device includes at least one of the followings: a single device, multiple devices indicated in a list and a device group.

In an example embodiment, a process of managing the target device according to the management operation or capability of the device troubleshooting service includes: implementing the management operation or capability of the device troubleshooting service based on scheduling.

In an example embodiment, a message exchange mode used by the management operation or capability of the device troubleshooting service includes at least one of the followings: a requesting and responding mode used for receiving a request and sending a response synchronously; and a requesting and asynchronization informing mode used for reporting to the application entity after an operation is finished.

In an example embodiment, the management operation or capability of the device troubleshooting service includes: restarting a device; wherein, input information of restarting the device includes: a device identifier; and return information of restarting the device includes: a response type.

In an example embodiment, the management operation or capability of the device troubleshooting service includes: resetting a device; wherein, input information of resetting the device includes: a device identifier, and return information of resetting the device includes: a response type.

In an example embodiment, the management operation or capability of the device troubleshooting service includes: uploading a device log; wherein, input information of uploading the device log includes at least one of the followings: a device identifier, a log type identifier, a log data and a log action state; and return information of uploading the device log includes at least one of the followings: a response type and a device log uniform resource locator.

In an example embodiment, the management operation or capability of the device troubleshooting service includes: locking a device, wherein, input information of locking the device includes: a device identifier; and return information of locking the device includes at least one of the followings: a response type and a locking state.

In an example embodiment, the management operation or capability of the device troubleshooting service includes: backing up a device; wherein, input information of backing up the device includes: a device identifier; and return information of backing up the device includes at least one of the followings: a response type, a backup identifier and a backup uniform resource locator.

In an example embodiment, the management operation or capability of the device troubleshooting service includes: recovering a device; wherein, input information of recovering the device includes at least one of the followings: a device identifier, a backup identifier and a backup uniform resource locator; and return information of recovering the device includes: a response type.

In an example embodiment, the management operation or capability of the device troubleshooting service includes: reporting a troubleshooting state; wherein, input information of reporting the troubleshooting state includes at least one of the followings: a final reporting mark, a sequence number, a troubleshooting reporting list and an aggregation strategy; the troubleshooting reporting list includes one or more troubleshooting reports, and each troubleshooting report includes at least one of the followings: a group identifier, a device identifier, a management operation, an operation result or state; the management operation includes at least one of the followings: restarting a device, resetting a device, uploading a device log, locking a device, backing up a device and recovering a device; and return information of reporting troubleshooting state includes: a response type.

In an example embodiment, the management operation or capability of the device troubleshooting service includes: obtaining all device logs; wherein, input information of obtaining all device logs includes: a device identifier; return information of obtaining all device logs includes at least one of the followings: a response type and a device log list; and the device log list includes one or more device logs; and each device log includes at least one of the followings: a log type identifier, log data, a log action state and a device log uniform resource locator.

In an example embodiment, the management operation or capability of the device troubleshooting service includes: obtaining device log information; wherein, input information of obtaining the device log information includes at least one of the followings: a device identifier, a log selecting condition and a device log uniform resource locator; the log selecting condition includes at least one of the followings: a log type identifier, a start time point and an end time point; return information of obtaining the device log information includes at least one of the followings: a response type and a device log; and the device log includes at least one of the followings: a log type identifier, log data, a log action state and a device log uniform resource locator.

In an example embodiment, the management operation or capability of the device troubleshooting service includes: testing a device connectivity; wherein, input information of testing the device connectivity includes at least one of the followings: a device identifier, a domain address, an internet protocol address and an underlying network address; the underlying network address includes at least one of the followings: a second generation (2G) of mobile network address, a third generation (3G) of mobile network address, a fourth generation (4G) of mobile network address, a wireless local area network address, a fixed network address, a worldwide interoperability for microwave access (WiMAX) address and a ZigBee network address; and return information of testing the device connectivity includes at least one of the followings: a response type and a connectivity report.

In an example embodiment, the log type identifier includes at least one of the followings: a system, a security, an event, a tracking and a panic.

In an example embodiment, the log action state includes at least one of the followings: started, stopped, unknown, non-existent and wrong.

In an example embodiment, receiving the management operation or capability of the device troubleshooting service requested by the application entity includes: adapting the management operation or capability of the device troubleshooting service to an operation corresponding to a device management server.

In an example embodiment, the device management server includes: a device management server in an underlying network of a public Internet of things or a device management server in other server domains.

In an example embodiment, the device management server supports at least one of the following protocols: an extensible messaging and presence protocol (XMPP), a message queuing telemetry transport (MQTT), an open mobile alliance device management protocol (OMA DM), a broadband forum customer premise equipment wide area network management protocol (BBF CWMP), and an open mobile alliance lightweight machine to machine protocol (OMA lightweight M2M).

Another embodiment of the disclosure discloses a device for a device troubleshooting service of the Internet of things, including: a managing component, arranged to receive a management operation or capability of a device troubleshooting service requested by an application entity, and manage a target device according to the management operation or capability of the device troubleshooting service; and a feedback component, arranged to provide the application entity with at least one of an operation result and an operation state.

In an example embodiment, the managing component is arranged to manage at least one of the following target devices: a single device, multiple devices indicated in a list and a device group.

In an example embodiment, the managing component is further arranged to implement the management operation or capability of the device troubleshooting service based on scheduling.

In an example embodiment, the managing component is further arranged to adapt the management operation or capability of the device troubleshooting service to an operation corresponding to a device management server.

In an example embodiment, the managing component is further arranged to adapt the management operation or capability of the device troubleshooting service to the following device management serves: a device management server in an underlying network of a public Internet of things or a device management server in other server domains.

Another embodiment of the disclosure discloses a system for a device troubleshooting service of the Internet of things, including: an application entity, arranged to request a device troubleshooting service; and a general service entity, arranged to receive a management operation or capability of the device troubleshooting service requested by the application entity, manage a requested target device according to the management operation or capability of the device troubleshooting service; and provide the application entity with at least one of an operation result and an operation state.

In an example embodiment, the system further includes: a management adapter, arranged to adapt the management operation or capability of the device troubleshooting service to an operation corresponding to a device management server.

In the embodiments of the disclosure, the management operation or capability of the device troubleshooting service requested by the application entity is received and the target device is managed according to the management operation or capability of the device troubleshooting service, and the application entity is provided with at least one of the operation result and the operation state, thereby realizing a uniform management of the device troubleshooting service in a public Internet of things and other Internet of things domains.

### BRIEF DESCRIPTION OF THE DRAWINGS

The drawings here are used for further describing the disclosure, be part of the disclosure, the embodiments and description thereof are used for describing the disclosure, and not intended to limit the disclosure. In drawings:

FIG. 1 shows a schematic diagram of a system of the Internet of things according to the related art;

FIG. 2 shows a flowchart of a method for a device troubleshooting service of the Internet of things according to an embodiment of the disclosure;

FIG. 3 shows a structural block diagram of a device for a device troubleshooting service of the Internet of things according to an embodiment of the disclosure;

FIG. 4a shows a schematic diagram of a system for a device troubleshooting service of the Internet of things according to an embodiment of the disclosure;

FIG. 4b shows a schematic diagram of a system for a device troubleshooting service of the Internet of things according to another embodiment of the disclosure;

FIG. 5 shows a schematic flowchart of a method for a device troubleshooting service of the Internet of things in a first example embodiment of the disclosure;

FIG. 6 shows a schematic flowchart of a method for a device troubleshooting service of the Internet of things in a second example embodiment of the disclosure.

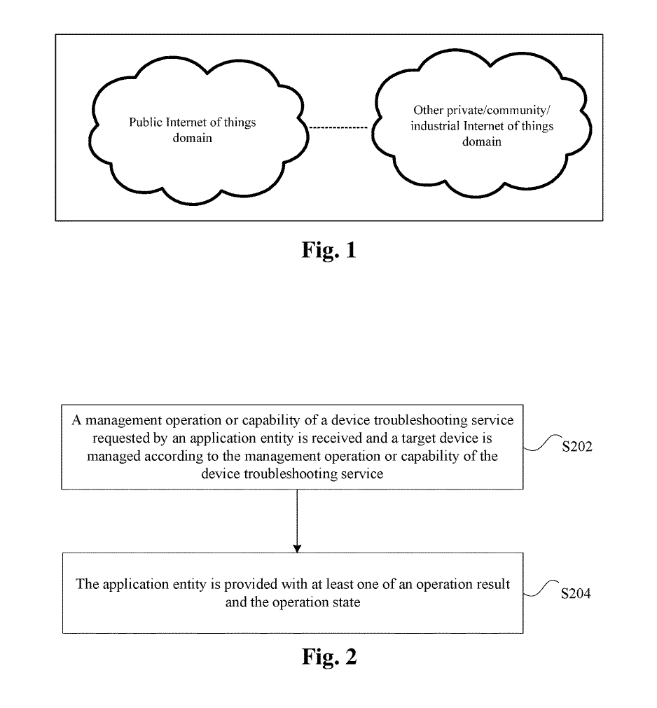

### DETAILED DESCRIPTION

The disclosure is further described below with reference to the drawings and the embodiments. It needs to be noted that the embodiments and characteristics in the embodiments of the disclosure can be combined mutually when no conflict exists.

A general service entity, an application entity in the following embodiments are described in an invention patent application that an application number is 2014101273881.1 and an invention name is “Method, Device and System for M2M Application Service”, and not repeated here again.

The device of the Internet of things in an embodiment of the disclosure includes at least one of the followings: a M2M terminal, a M2M gateway and a M2M server.

In an embodiment below, the M2M terminal can be a mobile terminal (such as a phone, a tablet computer etc.), or other type of terminals capable of accessing the Internet of things. An operation system run in the M2M terminal can be all kinds of systems, for example, an Android system used widely at present, or a windows operation system, an iphone operation system (iOS) of an Apple Inc etc., but not limited to these. The device can be a server, each type of gateway, or other types of devices.

The terminal or device can include a storage medium, a program element stored in the storage medium can be used for implementing the method described in the embodiment below. The terminal or device further can include a processor, and the processor is arranged to implement the program unit. It can be expected that the method or device described below can be realized through a computer program element.

In the embodiment below, other Internet of things domain can be a private Internet of things providing service for a single institution, other public Internet of things and a community Internet of things. Meanwhile, the Internet of things is widely applied in different industries, including an intelligent agriculture, a smart grid, an intelligent transportation, intelligent logistics, an intelligent healthcare, and a smart home etc.

FIG. 2 shows a flowchart of a method for a device troubleshooting service of the Internet of things according to an embodiment of the disclosure, as shown in FIG. 2, the method at least includes steps S202-S204:

S202: a management operation or capability of a device troubleshooting service requested by an application entity is received and a target device is managed according to the management operation or capability of the device troubleshooting service;

S204: the application entity is provided with at least one of an operation result and the operation state.

In the embodiments of the disclosure, the management operation or capability of the device troubleshooting service requested by the application entity is received and the target device is managed according to the management operation or capability of the device troubleshooting service, and the application entity is provided with at least one of the operation result and the operation state, thereby realizing a management of the device troubleshooting service.

In an example embodiment, the target device includes at least one of the followings: a single device, multiple devices indicated in a list and a device group.

In an example embodiment of the disclosure, in a process of managing the target device according to the management operation or capability of the device troubleshooting service, the management operation or capability of the device troubleshooting service can be implemented based on scheduling.

In an embodiment of the disclosure, a message exchange mode used by the management operation or capability of the device troubleshooting service includes at least one of the followings: a requesting and responding mode used for receiving a request and sending a response synchronously; and a requesting and asynchronization informing mode used for reporting to the application entity after an operation is finished.

In an embodiment of the disclosure, the management operation or capability of the device troubleshooting service includes: restarting a device; wherein input information of restarting the device includes: a device identifier; and return information of restarting the device includes: a response type.

In an embodiment of the disclosure, the management operation or capability of the device troubleshooting service includes: resetting a device; wherein input information of resetting the device includes: a device identifier, and return information of resetting the device includes: a response type.

In an embodiment of the disclosure, the management operation or capability of the device troubleshooting service includes: uploading a device log; wherein input information of uploading the device log includes at least one of the followings: a device identifier, a log type identifier, a log data and a log action state; and return information of uploading the device log includes at least one of the followings: a response type and a device log uniform resource locator.

In an embodiment of the disclosure, the management operation or capability of the device troubleshooting service includes: locking a device, wherein input information of locking the device includes: a device identifier; and return information of locking the device includes at least one of the follow: a response type and a locking state.

In an embodiment of the disclosure, the management operation or capability of the device troubleshooting service includes: backing up a device; wherein input information of backing up the device includes: a device identifier; and return information of backing up the device includes at least one of the followings: a response type, a backup identifier and a backup uniform resource locator.

In an embodiment of the disclosure, the management operation or capability of the device troubleshooting service includes: recovering a device; wherein input information of recovering the device includes at least one of the followings: a device identifier, a backup identifier and a backup uniform resource locator; and return information of recovering the device at least includes: a response type.

In an embodiment of the disclosure, the management operation or capability of the device troubleshooting service includes: reporting a troubleshooting state; wherein the input information of reporting the troubleshooting state includes at least one of the followings: a final reporting mark, a sequence number, a troubleshooting reporting list and an aggregation strategy; the troubleshooting reporting list includes one or more troubleshooting reports, and each troubleshooting report includes at least one of the followings: a group identifier, the device identifier, a management operation, an operation result or state; the management operation includes at least one of the followings: restarting a device, resetting a device, uploading a device log, locking a device, backing up a device and recovering a device; and return information of reporting troubleshooting state includes: a response type.

In an embodiment of the disclosure, the management operation or capability of the device troubleshooting service includes: obtaining all device logs; wherein input information of obtaining all device logs includes: a device identifier; return information of obtaining all device logs includes at least one of the followings: a response type and a device log list; the device log list includes one or more device logs; and each device log includes at least one of the followings: a log type identifier, log data, a log action state and a device log uniform resource locator.

In an embodiment of the disclosure, the management operation or capability of the device troubleshooting service includes: obtaining device log information; wherein input information of obtaining the device log information includes at least one of the followings: a device identifier, a log selecting condition and a device log uniform resource locator; the log selecting condition includes at least one of the followings: a log type identifier, a start time point and an end time point; return information of obtaining the device log information includes at least one of the followings: a response type and a device log; and the device log includes at least one of the followings: a log type identifier, log data, a log action state and a device log uniform resource locator.

In an embodiment of the disclosure, the management operation or capability of the device troubleshooting service includes: testing a device connectivity; wherein input information of testing the device connectivity includes at least one of the followings: a device identifier, a domain address, an internet protocol address and an underlying network address; the underlying network address includes at least one of the followings: a second generation (2G) of mobile network address, a third generation (3G) of mobile network address, a fourth generation (4G) of mobile network address, a wireless local area network address, a fixed network address, a worldwide interoperability for microwave access (WiMAX) address, and a ZigBee network address; and return information of testing the device connectivity includes at least one of the followings: a response type and a connectivity report.

In an embodiment of the disclosure, the log type identifier includes at least one of the followings: a system, a security, an event, a tracking and a panic.

In an embodiment of the disclosure, the log action state includes at least one of the followings: started, stopped, unknown, non-existent and wrong.

In an embodiment of the disclosure, receiving the management operation or capability of the device troubleshooting service requested by the application entity includes: the management operation or capability of the device troubleshooting service is adapted to an operation corresponding to a device management server.

In an embodiment of the disclosure, the device management server includes a device management server in an underlying network of a public Internet of things or a device management server in other server domains.

In an example embodiment, the device management server supports at least one of the following protocols: an extensible messaging and presence protocol (XMPP), a message queuing telemetry transport (MQTT), an open mobile alliance device management protocol (OMA DM), a broadband forum customer premise equipment wide area network management protocol (BBF CWMP), and an open mobile alliance lightweight machine to machine protocol (OMA lightweight M2M).

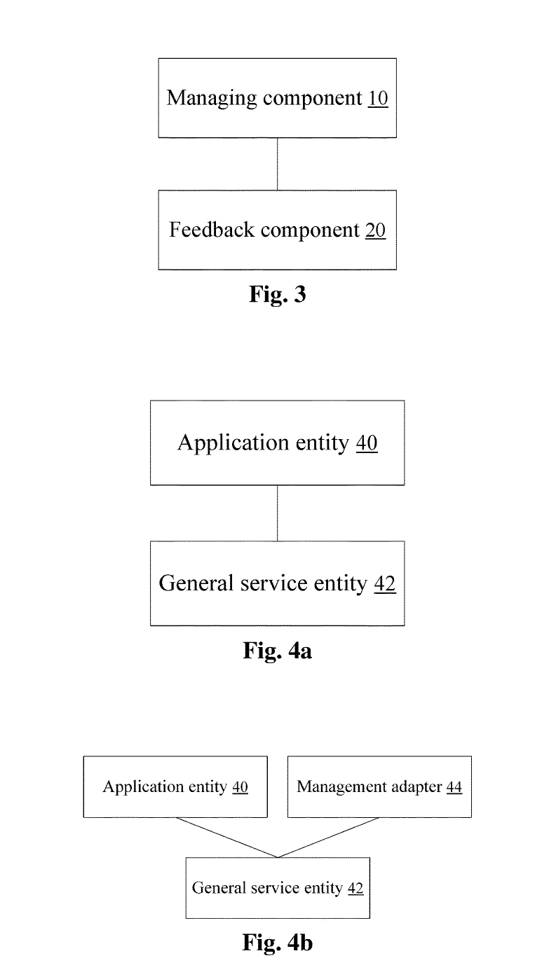

FIG. 3 shows a structural block diagram of a device for a device troubleshooting service of the Internet of things according to an embodiment of the disclosure, as shown in FIG. 3, the device includes: a managing component 10, arranged to receive a management operation or capability of a device troubleshooting service requested by an application entity, and manage a target device according to the management operation or capability of the device troubleshooting service; and a feedback component 20, connected to the managing component 10 and arranged to provide the application entity with at least one of an operation result and an operation state.

In an example embodiment, the target device includes at least one of the followings: a single device, multiple devices indicated in a list and a device group.

In an embodiment of the disclosure, the management operation or capability of the device troubleshooting service is implemented based on scheduling.

In an example embodiment, the managing component 10 is further arranged to adapt the management operation or capability of the device troubleshooting service to an operation corresponding to a device management server.

In an example embodiment, the device management server includes: a device management server in an underlying network of a public Internet of things or a device management server in other server domains.

It needs to be noted that, the method applied in the device corresponds to the method described above and is not repeated here again.

FIG. 4a shows a schematic diagram of a system for a device troubleshooting service of the Internet of things according to an embodiment of the disclosure, as shown in FIG. 4a, the system includes: an application entity 40, arranged to request a device troubleshooting service; a general service entity 42 connected with the application entity 40 and arranged to receive a management operation or capability of the device troubleshooting service requested by the application entity, manage a target device according to the management operation or capability of the device troubleshooting service, and provide the application entity with at least one of an operation result and an operation state.

In another example embodiment, as shown in FIG. 4b, the system further includes: a management adapter 44, connected with the general service entity 42 and arranged to adapt the management operation or capability of the device troubleshooting service to an operation corresponding to a device management server.

It needs to be noted that, the method applied in the system corresponds to the method described above and is not repeated here again.

The example embodiments of the disclosure are described below with reference to the embodiments, and obviously the example embodiments are not limited to the method below. A specific structure of the general service entity in the example embodiments below is described in an invention patent application that the application number is 2014101273881.1 and the invention name is “Method, Device and System for M2M Application Service”, and not repeated here again.

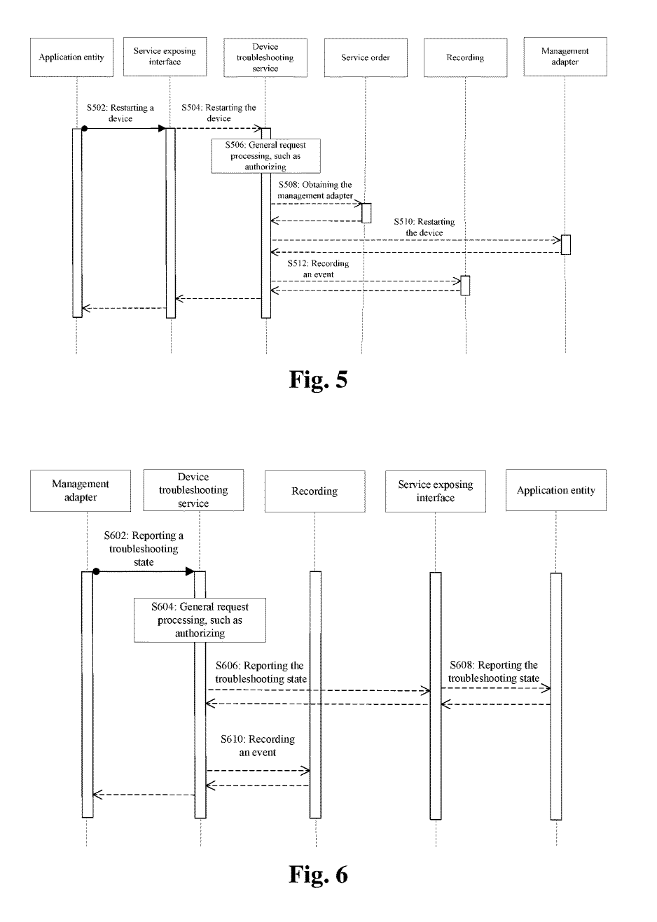

FIG. 5 shows a schematic flowchart of a method for a device troubleshooting service of the Internet of things according to a first example embodiment of the disclosure, as shown in FIG. 5, the method at least includes steps S502-S512:

S502: an application entity sends a device restarting request to a service exposing interface of the device troubleshooting service;

S504: the service exposing interface transmits the device restarting request to the device troubleshooting service;

S506: the device troubleshooting service calls a general processing request, such as authorizing;

S508: the device troubleshooting service obtains a management adapter through a service order relation;

S510: the device troubleshooting service sends the device restarting request to the management adapter; and the management adapter subsequently calls the device management server in an underlying network of a public Internet of things or device management servers in other server domains, in which each device management server supports at least one of the following protocols: the XMPP, the MQTT, the OMA DM, the BBF CWMP, and the OMA lightweight M2M.

S512: the device troubleshooting service records an event.

FIG. 6 shows a schematic flowchart of a method for a device troubleshooting service of the Internet of things in a second example embodiment of the disclosure, as shown in FIG. 6, the method at least includes steps S602-S610:

S602: a management adapter obtains a troubleshooting operation result or state report of a device management server in an underlying network of a public Internet of things or device management servers in other server domains, and sends a troubleshooting state inform to the device troubleshooting service;

S604: the device troubleshooting service calls a general processing request, such as authorizing;

S606: the device troubleshooting service transmits the troubleshooting state inform to a service exposing interface;

S608: the service exposing interface transmits the troubleshooting state inform to an application entity;

S610: the device troubleshooting service records an event.

In view of this, the disclosure realizes the technical effects below: solving the problem of uniformly managing the devices of the public Internet of things and other Internet of things, and realizing the uniform troubleshooting service of devices in the public Internet of things and other Internet of things.

Another embodiment discloses software, and the software is arranged to implement the technical solution described in the embodiments and the example embodiments above.

Another embodiment discloses a storage medium, the software above is stored in the storage medium; and the storage medium includes, but not limited to, a disk, a floppy disk, hard disk and an erasable memory etc.

Obviously, those skilled in the art shall understand that all of the above-mentioned components or steps in the disclosure may be implemented by using a general calculation apparatus, may be centralized on a single calculation apparatus or may be distributed on a network composed of multiple calculation apparatuses. Alternatively, they may be implemented by using executable program codes of the calculation apparatus. Thus, they may be stored in a storage apparatus and executed by the calculation apparatuses, the shown or described steps may be executed in a sequence different from the sequence under certain conditions, or they are manufactured into each integrated circuit component respectively, or multiple component or steps therein are manufactured into a single integrated circuit component. Thus, the disclosure is not limited to combination of any specific hardware and software.

The above is only the example embodiments of the disclosure, and not intended to limit the disclosure. There may be various modifications and variations in the disclosure for those skilled in the art. Any modifications, equivalent replacements, improvements and the like made within the spirit and principle of the disclosure shall fall within the scope of the protection of the disclosure.

### INDUSTRIAL APPLICABILITY

The technical solution disclosed in embodiments of the disclosure, a management operation or capability of a device troubleshooting service requested by an application entity is received and a target device is managed according to the management operation or capability of the device troubleshooting service; and the application entity is provided with at least one of an operation result and an operation state, thereby realizing a uniform management of the device troubleshooting service in a public Internet of things and other Internet of things.

1. A method for a device troubleshooting service of the Internet of things, comprising:
receiving a management operation or capability of a device troubleshooting service requested by an application entity, and managing a target device according to the management operation or capability of the device troubleshooting service; and
providing the application entity with at least one of an operation result and an operation state.

2. The method as claimed in claim 1, wherein, the target device comprises at least one of the followings: a single device, multiple devices indicated in a list and a device group;
or a process of managing the target device according to the management operation or capability of the device troubleshooting service comprises: implementing the management operation or capability of the device troubleshooting service based on scheduling;
or a message exchange mode used by the management operation or capability of the device troubleshooting service comprises at least one of the followings: a requesting and responding mode used for receiving a request and sending a response synchronously; and a requesting and asynchronization informing mode used for reporting to the application entity after an operation is finished.

3. (canceled)

4. (canceled)

5. The method as claimed in claim 1, wherein, the management operation or capability of the device troubleshooting service comprises: restarting a device; wherein,
input information of restarting the device comprises: a device identifier; and
return information of restarting the device comprises: a response type.

6. The method as claimed in claim 1, wherein, the management operation or capability of the device troubleshooting service comprises: resetting a device; wherein,
input information of resetting the device comprises: a device identifier, and
return information of resetting the device comprises: a response type.

7. The method as claimed in claim 1, wherein, the management operation or capability of the device troubleshooting service comprises: uploading a device log; wherein,
input information of uploading the device log comprises at least one of the followings: a device identifier, a log type identifier, a log data and a log action state; and
return information of uploading the device log comprises at least one of the followings: a response type and a device log uniform resource locator.

8. The method as claimed in claim 1, wherein, the management operation or capability of the device troubleshooting service comprises: locking a device, wherein,
input information of locking the device comprises: a device identifier; and
return information of locking the device comprises at least one of the followings: a response type and a locking state.

9. The method as claimed in claim 1, wherein, the management operation or capability of the device troubleshooting service comprises: backing up a device; wherein,
input information of backing up the device comprises: a device identifier; and
return information of backing up the device comprises at least one of the followings: a response type, a backup identifier and a backup uniform resource locator.

10. The method as claimed in claim 1, wherein, the management operation or capability of the device troubleshooting service comprises: recovering a device; wherein,
input information of recovering the device comprises at least one of the followings: a device identifier, a backup identifier and a backup uniform resource locator; and
return information of recovering the device comprises: a response type.

11. The method as claimed in claim 1, wherein, the management operation or capability of the device troubleshooting service comprises: reporting a troubleshooting state; wherein,
input information of reporting the troubleshooting state comprises at least one of the followings: a final reporting mark, a sequence number, a troubleshooting reporting list and an aggregation strategy;
the troubleshooting reporting list comprises one or more troubleshooting reports, and each troubleshooting report comprises at least one of the followings: a group identifier, a device identifier, a management operation, an operation result or state;
the management operation comprises at least one of the followings: restarting a device, resetting a device, uploading a device log, locking a device, backing up a device and recovering a device;
and return information of reporting troubleshooting state comprises: a response type.

12. The method as claimed in claim 1, wherein, the management operation or capability of the device troubleshooting service comprises: obtaining all device logs; wherein,
input information of obtaining all device logs comprises: a device identifier;
return information of obtaining all device logs comprises at least one of the followings: a response type and a device log list; and
the device log list comprises one or more device logs; and each device log comprises at least one of the followings: a log type identifier, log data, a log action state and a device log uniform resource locator.

13. The method as claimed in claim 1, wherein, the management operation or capability of the device troubleshooting service comprises: obtaining device log information; wherein,
input information of obtaining the device log information comprises at least one of the followings: a device identifier, a log selecting condition and a device log uniform resource locator;
the log selecting condition comprises at least one of the followings: a log type identifier, a start time point and an end time point;
return information of obtaining the device log information comprises at least one of the followings: a response type and a device log; and
the device log comprises at least one of the followings: a log type identifier, log data, a log action state and a device log uniform resource locator.

14. The method as claimed in claim 1, wherein, the management operation or capability of the device troubleshooting service comprises: testing a device connectivity; wherein,
input information of testing the device connectivity comprises at least one of the followings: a device identifier, a domain address, an internet protocol address and an underlying network address;
the underlying network address comprises at least one of the followings: a second generation (2G) of mobile network address, a third generation (3G) of mobile network address, a fourth generation (4G) of mobile network address, a wireless local area network address, a fixed network address, a worldwide interoperability for microwave access (WiMAX) address and a ZigBee network address; and
return information of testing the device connectivity comprises at least one of the followings: a response type and a connectivity report.

15. The method as claimed in claim 7, wherein,
the log type identifier comprises at least one of the followings: a system, a security, an event, a tracking and a panic;
or the log action state comprises at least one of the following: started, stopped, unknown, non-existent and wrong.

16. (canceled)

17. The method as claimed in claim 1, wherein, receiving the management operation or capability of the device troubleshooting service requested by the application entity comprises:
adapting the management operation or capability of the device troubleshooting service to an operation corresponding to a device management server.

18. The method as claimed in claim 17, wherein, the device management server comprises: a device management server in an underlying network of a public Internet of things or a device management server in other server domains;
or the device management server supports at least one of the following protocols: an extensible messaging and presence protocol (XMPP), a message queuing telemetry transport (MQTT), an open mobile alliance device management protocol (OMA DM), a broadband forum customer premise equipment wide area network management protocol (BBF CWMP), and an open mobile alliance lightweight machine to machine protocol (OMA lightweight M2M).

19. (canceled)

20. A device for a device troubleshooting service of the Internet of things, comprising:
a managing component, arranged to receive a management operation or capability of a device troubleshooting service requested by an application entity, and manage a target device according to the management operation or capability of the device troubleshooting service; and
a feedback component, arranged to provide the application entity with at least one of an operation result and an operation state.

21. The device as claimed in claim 20, wherein, the managing component is arranged to manage at least one of the following target devices: a single device, multiple devices indicated in a list and a device group;
or the managing component is further arranged to implement the management operation or capability of the device troubleshooting service based on scheduling;
or the managing component is further arranged to adapt the management operation or capability of the device troubleshooting service to an operation corresponding to a device management server.

22. (canceled)

23. (canceled)

24. The device as claimed in claim 21, wherein, the managing component is further arranged to adapt the management operation or capability of the device troubleshooting service to the following device management serves: a device management server in an underlying network of a public Internet of things or a device management server in other server domains.

25. A system for a device troubleshooting service of the Internet of things, comprising:
an application entity, arranged to request a device troubleshooting service; and
a general service entity, arranged to receive a management operation or capability of the device troubleshooting service requested by the application entity, manage a requested target device according to the management operation or capability of the device troubleshooting service; and provide the application entity with at least one of an operation result and an operation state.

26. The system as claimed in claim 25, wherein, further comprising:
a management adapter, arranged to adapt the management operation or capability of the device troubleshooting service to an operation corresponding to a device management server.
